(19) United States
(12) Patent Application Publication
(10) Pub. No.: US 2024/0399509 A1
(43) Pub. Date: Dec. 5, 2024

(54) METHOD OF MANUFACTURING WAFER

(71) Applicant: DISCO CORPORATION, Tokyo (JP)

(72) Inventor: Kazuki MORI, Tokyo (JP)

(21) Appl. No.: 18/671,087

(22) Filed: May 22, 2024

(30) Foreign Application Priority Data
May 30, 2023 (JP) 2023-089125

(51) Int. Cl. B23K 26/53; B23K 26/06; B23K 26/073; B23K 26/38; B23K 101/40

(52) U.S. Cl. CPC B23K 26/53; B23K 26/0648; B23K 26/073; B23K 26/38; B23K 2101/40

(57) ABSTRACT

A method of manufacturing a wafer includes a peel-off layer forming step of forming a plurality of peel-off layers in a workpiece by, while a focused spot of a pulsed laser beam having a wavelength transmittable through the workpiece is positioned at a predetermined depth in the workpiece, alternately repeating processing-feeding for moving the workpiece and the focused spot of the laser beam relative to each other along a first direction and indexing-feeding for moving the workpiece and a condensing lens relative to each other along a second direction wherein the first and second directions are perpendicular to thicknesswise directions of the workpiece, a crack developing step of applying the laser beam to the modified layer of at least one of the peel-off layers formed in the peel-off layer forming step, and a peeling step of peeling off a wafer from the workpiece at the peel-off layers.

### BACKGROUND OF THE INVENTION

### Field of the Invention

The present invention relates to a method of manufacturing a wafer from a workpiece such as an ingot or a monocrystalline substrate, the wafer having a thickness smaller than the thickness of the workpiece.

### Description of the Related Art

There have been known wire saws as means for slicing wafers from ingots made of a compound semiconductor such as silicon carbide (SiC) (see, for example, JP-H9-262826A). A wire saw requires a relatively large cutting allowance compared with the thickness of a wafer that the wire saw cuts from an ingot. Further, the wafer sliced from the ingot needs lapping in order to planarize the surface of the wafer.

When wafers are cut from an ingot by a wire saw, therefore, the volume of the ingot material that is discarded compared with the volume of the wafers produced from the ingot is relatively large. Consequently, cutting wafers from an ingot with a wire saw is problematic in that productivity is relatively low.

For achieving higher productivity in producing wafers from ingots, there has been proposed a method of forming a plurality of mechanically fragile peel-off layers at a predetermined depth in an ingot made of a compound semiconductor by applying a pulsed laser beam having a wavelength transmittable through the ingot and then peeling off a wafer from the ingot at the peel-off layers that act as peel-off initiating points (see, for example, JP2016-111143A).

Specifically, while the focused spot of the laser beam applied to the ingot is being positioned at the predetermined depth in the ingot, the ingot is moved relative to the focused spot of the laser beam along a processing-feed direction perpendicular to the thicknesswise directions of the ingot. The laser beam thus applied forms in the ingot a peel-off layer including a modified layer and cracks developed from the modified layer.

After the peel-off layer has been formed in the ingot, the ingot is moved a predetermined distance along an indexing-feed direction perpendicular to the processing-feed direction and the thicknesswise directions of the ingot. The laser beam is applied again to the ingot while positioning the focused spot thereof at the predetermined depth in the ingot, and at the same time the ingot is processing-fed again with respect to the focused spot of the laser beam, thereby forming another peel-off layer at the predetermined depth in the ingot.

In this fashion, a plurality of peel-off layers are formed at the predetermined depth in the ingot, after which the wafer is peeled off from the ingot at the peel-off layers acting as peel-off initiating points. Then, surface irregularities remaining on the surface of the wafer that has left the ingot at the peel-off layers and the surface of the ingot from which the wafer has been peeled off are removed by grinding or polishing.

The peel-off layers have a thickness that is small compared with the cutting allowance that would be required of the ingot by a wire saw, and there is no need to lap the wafer peeled off from the ingot. Therefore, by peeling off a wafer from an ingot made of a compound semiconductor with use of a laser beam, the volume of the ingot material that is discarded or lost can be reduced compared with the case of using a wire saw.

However, there are demands in the art for a further reduction in the loss of material caused when wafers are peeled off from workpieces including ingots and monocrystalline substrates. The loss of material from a workpiece at the time the workpiece is processed to form peel-off layers therein by a laser beam increases mainly depending on the length of cracks developed along the thicknesswise directions of the workpiece. The higher the average output power level of the laser beam applied to the workpiece is, the easier the formation of the modified layers in the workpiece becomes, but the easier the development of the cracks along the thicknesswise directions of the workpiece also becomes, i.e., the greater the damage caused to the workpiece by the laser beam becomes.

In view of the difficulties described above, it has been proposed to lower the average output power level of the laser beam and to reduce the spaced intervals between the modified layers along the indexing-feed directions, as a laser processing method for reducing the loss of material from the workpiece (see, for example, JP2022-517543A). According to the laser processing method disclosed in JP2022-517543A, a plurality of linear first modified layers lying parallel to each other are formed at a predetermined depth in an ingot by a laser beam, and then a plurality of linear second modified layers are formed between the first modified layers in the ingot by the laser beam.

According to the above laser processing method, however, when the second modified layers are formed in the ingot by the laser beam, cracks that are present to interconnect two of the first modified layers reflect the laser beam, and the reflected laser beam is liable to cause damage to a region of the ingot that is to be peeled off into a wafer. As a result, the loss of material from the ingot tends to be increased.

### SUMMARY OF THE INVENTION

The present invention has been devised in view of the above problems. It is an object of the present invention to provide a method of manufacturing a wafer from a workpiece while reducing the loss of material from the workpiece compared with the case of forming second modified layers between a plurality of linear first modified layers lying parallel to each other in a workpiece at the time when peel-off layers are formed in the workpiece.

In accordance with an aspect of the present invention, there is provided a method of manufacturing a wafer from a workpiece shaped as an ingot or a monocrystalline substrate, the wafer having a thickness smaller than a thickness of the workpiece. The method includes a peel-off layer forming step, a crack developing step, and a peeling step. The peel-off layer forming step forms in the workpiece a plurality of peel-off layers each including a modified layer extending along a first direction that is perpendicular to thicknesswise directions of the workpiece and cracks developed from the modified layer by, while a condensing lens for converging a pulsed laser beam having a wavelength transmittable through the workpiece is adjusted to a predetermined height so as to position a focused spot of the laser beam at a predetermined depth in the workpiece, alternately repeating processing-feeding for moving the workpiece and the focused spot of the laser beam relative to each other along the first direction and indexing-feeding for moving the workpiece and the condensing lens relative to each other along a second direction that is perpendicular to the thicknesswise directions of the workpiece and the first direction. The crack developing step further develops the cracks that have been developed from the modified layer of at least one of the peel-off layers formed in the peel-off layer forming step and/or develops new cracks from the modified layer of the at least one of the peel-off layers by applying the laser beam to the modified layer of the at least one of the peel-off layers along longitudinal directions of the modified layer. The peeling step peels off the wafer from the workpiece at the peel-off layers that act as peel-off initiating points.

Preferably, the crack developing step includes applying the laser beam to the modified layers of an every predetermined number of ones of the peel-off layers that are arrayed along the second direction.

Preferably, the crack developing step includes an irradiating step of irradiating, with the laser beam, the modified layers of a first number of peel-off layers that are successively arrayed in the second direction with no unirradiated modified layers being present amidst the modified layers, and an unirradiating step of leaving, unirradiated with the laser beam, the modified layers of a second number of peel-off layers that are disposed adjacent in the second direction to the first number of peel-off layers that are successively arrayed in the second direction, the irradiating step and the unirradiating step being alternately repeated along the second direction.

Preferably, the crack developing step includes applying to the workpiece a laser beam having an output power level equal to or lower than an output power level of the laser beam applied to the workpiece in the peel-off layer forming step.

Preferably, the crack developing step includes applying the laser beam to the workpiece after having adjusted the height of the focused spot of the laser beam to a height same as the height of the focused spot in the peel-off layer forming step.

In the method of manufacturing a wafer according to the aspect of the present invention, the laser beam is applied along the modified layers formed in the peel-off layer forming step, to further develop the cracks that have been developed from the modified layers and/or to develop new cracks from the modified layers in the crack developing step. In the crack developing step, therefore, the laser beam is not reflected by cracks that would otherwise be formed between two modified layers when the laser beam is applied between the two modified layers. The loss of material of the workpiece is thus reduced as the workpiece is not damaged by a reflected laser beam therein.

The above and other objects, features and advantages of the present invention and the manner of realizing them will become more apparent, and the invention itself will best be understood from a study of the following description and appended claims with reference to the attached drawings showing a preferred embodiment of the present invention.

### BRIEF DESCRIPTION OF THE DRAWINGS

FIG. 1 is a flowchart of a sequence of a method of manufacturing a wafer according to an embodiment of the present invention;

FIG. 2A is a plan view of an SiC ingot;

FIG. 2B is a perspective view of the SiC ingot;

FIG. 3 is a schematic side elevational view, partly in block form, of a laser processing apparatus;

FIG. 4A is a plan view schematically illustrating the sic ingot being processed in a peel-off layer forming step of the method;

FIG. 4B is a plan view schematically illustrating the SiC ingot with a plurality of peel-off layers formed therein in the peel-off layer forming step;

FIG. 5 is an enlarged fragmentary cross sectional view illustrating the SiC ingot being partly processed in a crack developing step of the method;

FIG. 6 is a plan view illustrating the SiC ingot entirely processed in the crack developing step;

FIG. 7A is an enlarged fragmentary cross sectional view illustrating the SiC ingot in which cracks are being developed in the crack developing step;

FIG. 7B is an enlarged fragmentary cross sectional view illustrating the SiC ingot in which cracks are being developed in an SiC ingot having an off-angle;

FIG. 8A is a side elevational view illustrating the SiC ingot being processed in a peeling step of the method;

FIG. 8B is a side elevational view illustrating the SiC ingot and an SiC wafer after the peeling step;

FIG. 9 is an enlarged fragmentary cross sectional view of an SiC ingot in which a laser beam is reflected by cracks;

FIG. 10 is a plan view illustrating an SiC ingot processed in a crack developing step according to a first modification; and

FIG. 11 is a plan view illustrating an SiC ingot processed in a crack developing step according to a second modification.

### DETAILED DESCRIPTION OF THE PREFERRED EMBODIMENT

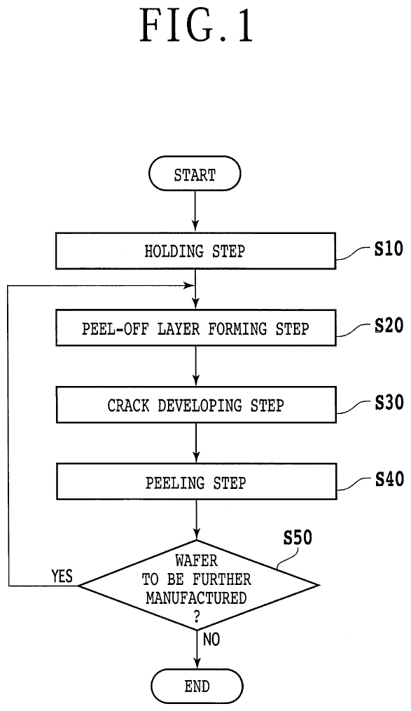

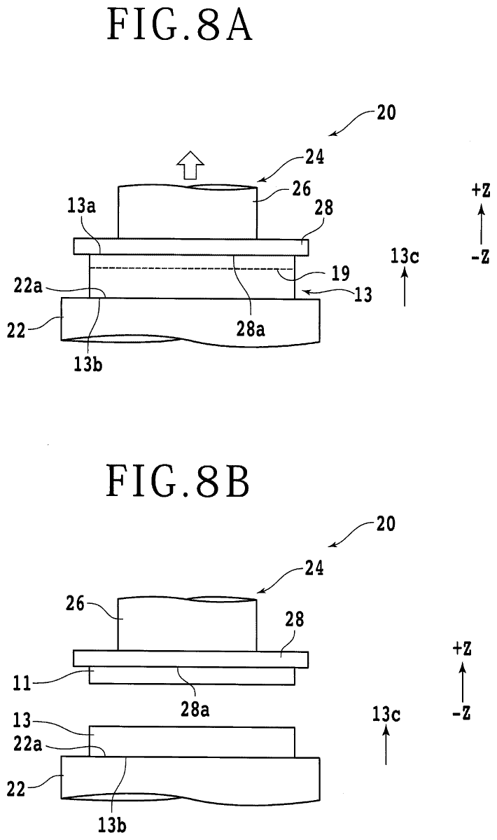

A preferred embodiment of the present invention will be described in detail below with reference to the accompanying drawings. FIG. 1 is a flowchart of a sequence of a method of manufacturing a wafer, i.e., an SiC wafer 11 (see FIG. 8B), according to the embodiment of the present invention. As illustrated in FIG. 1, the method includes a holding step S10, a peel-off layer forming step S20, a crack developing step S30, and a peeling step S40 that are carried out in succession.

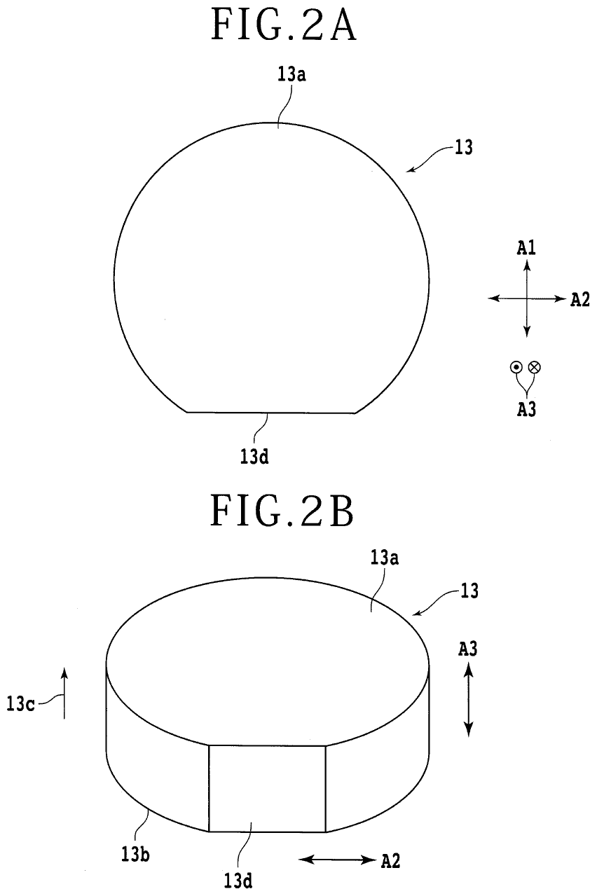

First, an SiC ingot, i.e., a workpiece, 13 from which to manufacture the SiC wafer 11 will be described below with reference to FIGS. 2A and 2B. FIG. 2A illustrates the SiC ingot 13 in plan, and FIG. 2B illustrates the SiC ingot 13 in perspective. The SiC ingot 13 is a single crystal of SiC having a hexagonal crystal structure. The SiC ingot 13 is not limited to any conductivity type and may be of p type or n type.

According to the present embodiment, the SiC ingot 13 has a diameter of 4 inches, i.e., approximately 100 mm, and a thickness of 500 μm, though it is not restricted to the specified diameter and thickness. The SiC ingot 13 has a first surface 13a and a second surface 13b that are opposite each other along a thicknesswise direction 13c.

According to the present embodiment, the SiC ingot 13 has no off-angle. In the present description, the SiC ingot 13 has crystal surfaces and orientations designated by Miller-Bravais indices. The first surface 13a is represented by (0001) and the second surface 13b by (000-1). The SiC ingot 13 has a flat surface 13d on its side that is to represent an orientation flat of the SiC wafer 11. According to the present embodiment, the flat surface 13d is represented by (−1100).

Particular crystal surfaces are represented using ( ) and crystal surfaces that are equivalent to each other owing to the symmetry of the crystal structure are represented using { }. Similarly, particular crystal orientations are represented using [ ], and crystal orientations that are equivalent to each other are represented using < >. An index accompanied by a negative sign is equal to an index with an overbar.

In FIG. 2A that illustrates the SiC ingot 13 in plan, first directions A1 perpendicular to the flat surface 13d extend parallel to [−1100]. Second directions A2 parallel to a straight line defined by the intersection of the first surface 13a and the flat surface 13d extend parallel to [11-20]. In FIG. 2B, third directions A3, or the thicknesswise direction 13c, perpendicular to the first directions A1 and the second directions C2 extend parallel to.

Since the SiC ingot 13 according to the present embodiment has no off-angle, the first directions A1 may be any directions perpendicular to <0001> parallel to the third directions A3. In this case, the second directions A2 are directions perpendicular to the first directions A1 and the third directions A3.

If the SiC ingot 13 has an off-angle, then the first directions A1 are established as directions, e.g., <−1100>, perpendicular to directions in which the off-angle is formed, e.g., <11-20>, and also perpendicular to <0001>, though they may be established within a deviation of ±5° from those directions, e.g., within a deviation of ±5° from <−1100>.

If the SiC ingot 13 has an off-angle, then the directions in which the off-angle is formed may be read as directions perpendicular to within a given plane defined by a vector normal to the first surface 13a of the SiC ingot 13 and of the SiC ingot 13.

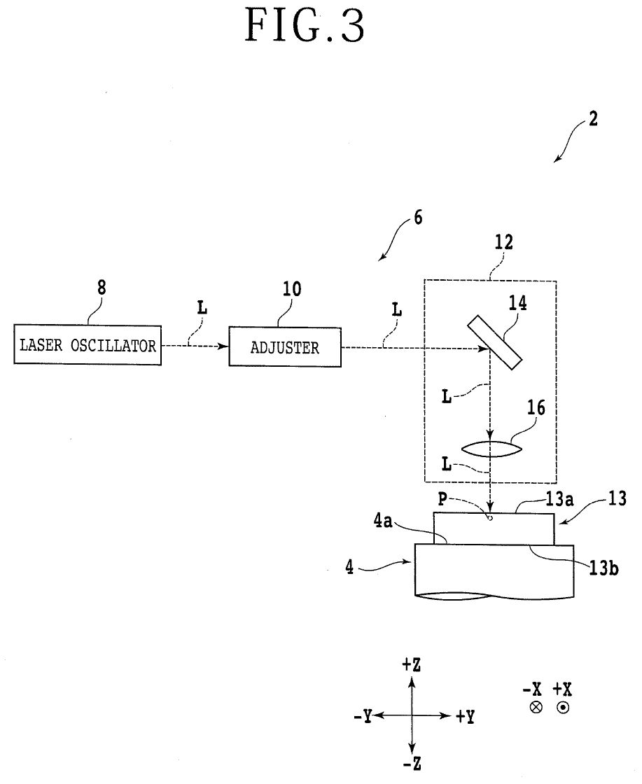

A laser processing apparatus 2 for performing laser processing on the SiC ingot 13 will be described below with reference to FIG. 3. FIG. 3 schematically illustrates in side elevation the laser processing apparatus 2 with some components depicted as functional blocks or in simplified forms.

In FIG. 3, the laser processing apparatus 2 is illustrated in reference to a three-dimensional coordinate system having an X-axis, i.e., a processing-feed direction, a Y-axis, i.e., an indexing-feed direction, and a Z-axis i.e., a heightwise direction, which extend perpendicularly to each other. The X-axis extends substantially parallel to the first directions A1. The Y-axis extends substantially parallel to the second directions A2. The Z-axis extends substantially parallel to the third directions A3 and the thicknesswise direction 13c.

The X-axis extends parallel to a +X direction and a −X direction that are oriented opposite each other. Similarly, the Y-axis extends parallel to a +Y direction and a −Y direction that are oriented opposite each other, and the Z-axis extends parallel to a +Z direction and a −Z direction that are oriented opposite each other.

The laser processing apparatus 2 has a disk-shaped chuck table 4 including a disk-shaped frame made of metal such as stainless steel. The frame has an upwardly open circular recess, not depicted, defined centrally therein that is smaller in diameter than the frame. The recess houses a disk-shaped porous plate, not depicted, made of porous ceramic that is fixedly fitted therein.

The frame also has a fluid channel, not depicted, defined therein that is fluidly connected to a vacuum source, not depicted, such as a vacuum pump via a pipe, not depicted. When the vacuum source is actuated, it generates and transmits a vacuum through the pipe and the fluid channel to the porous plate in the recess in the frame, developing a negative pressure on an upper surface of the porous plate.

The frame has an annular upper surface surrounding a circular upper surface of the porous plate. The annular upper surface of the frame and the circular upper surface of the porous plate lie essentially flush with each other and flatwise, and jointly function as a holding surface 4a for holding the SiC ingot 13 under suction thereon. The holding surface 4a lies substantially parallel to an XY plane that is defined by the X-axis and the Y-axis.

The chuck table 4 is disposed above a rotary drive mechanism, not depicted, for turning the chuck table 4 about its central axis along the Z-axis. When the rotary drive mechanism is actuated, it turns the chuck table 4 about its central axis through a desired angle.

The chuck table 4 and the rotary drive mechanism are supported on a horizontally moving mechanism, not depicted. The horizontally moving mechanism includes a ball-screw-type X-axis moving mechanism and a ball-screw-type Y-axis moving mechanism for moving the chuck table 4 together the rotary drive mechanism along the X-axis and the Y-axis, respectively.

The laser processing apparatus 2 includes a laser beam applying unit 6 disposed above the holding surface 4a. The laser beam applying unit 6 includes a laser oscillator 8 having a laser medium of Nd: YAG or Nd: YVO₄, for example.

The laser oscillator 8 generates and emits a pulsed laser beam L having a wavelength of 1064 nm, for example, which is transmittable through the SiC ingot 13. The laser beam L that is emitted from the laser oscillator 8 is applied to an adjuster 10 having an attenuator or the like. After the output power level of the laser beam L has been adjusted by the adjuster 10, the laser beam L travels from the adjuster 10 to a beam condenser 12.

The beam condenser 12 includes a mirror 14 disposed in an upper portion thereof for changing the direction of travel of the laser beam L. The beam condenser 12 also includes a condensing lens 16 disposed in a lower portion thereof for focusing the laser beam L. The condensing lens 16 may be fixedly disposed in the beam condenser 12 or may be movable therein by an actuator, not depicted.

The laser beam L that is applied to the mirror 14 is reflected by the mirror 14 and then converged into a focused spot P by the condensing lens 16 at a predetermined depth in the SiC ingot 13 held on the holding surface 4a. The beam condenser 12 is coupled to a ball-screw-type Z-axis moving mechanism, not depicted, that, when actuated, moves the focused spot P of the laser beam L vertically along the Z-axis by moving the beam condenser 12 vertically along the Z-axis.

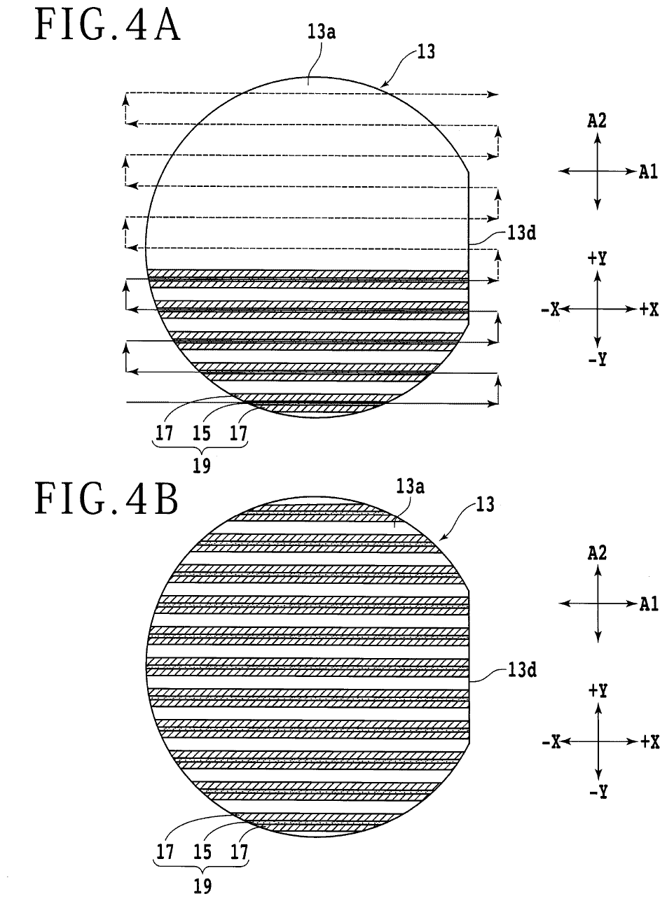

While the focused spot P is being positioned at the predetermined depth in the SiC ingot 13, the focused spot P and the chuck table 4 are moved relative to each other in the processing feed direction, i.e., processing-fed, along the X-axis by the horizontally moving mechanism to form a linear modified layer 15 (see FIGS. 4A and 4B) along the path followed by the focused spot P.

The modified layer 15 includes a region where the monocrystalline SiC has changed to amorphous silicon and amorphous carbon, i.e., a relatively fragile region with varied crystallinity compared with the remaining region of the SiC ingot 13 that has not been irradiated with the laser beam L.

In particular, the repetitive frequency of the laser beam L, the processing feed speed at which the focused spot P and the chuck table 4 are moved relative to each other, and the size of the focused spot P are adjusted to cause successive positions of the focused spot P to overlap each other along the third directions A3, so that the laser beam L is absorbed by the amorphous carbon that has a much higher absorption coefficient than the monocrystalline SiC, thereby forming a modified layer 15 in a flat region that is wider in the second directions A2 than in the third directions A3.

At the depth in the SiC ingot 13 where the modified layer 15 is formed, cracks 17 (see FIGS. 4A and 4B) are developed from the modified layer 15 essentially mainly along the second directions A2. Specifically, the cracks 17 are developed essentially mainly along the second directions A2 from both sides of the linear modified layer 15 in the second directions A2.

A microscope camera unit, not depicted, is disposed in the vicinity of the beam condenser 12. The microscope camera unit is movable in unison with the beam condenser 12 along the Z-axis by the Z-axis moving mechanism. The microscope camera unit has a light source including a light-emitting device such as a light-emitting diode (LED) and a solid-state image capturing device such as a charge-coupled-device (CCD) image sensor or a complementary-metal-oxide-semiconductor (CMOS) image sensor.

The chuck table 4, the rotary drive mechanism, the horizontally moving mechanism, the Z-axis moving mechanism, and the laser beam applying unit 6 described above are controlled in operation by a controller, not depicted. The controller is implemented by a computer, for example, including a processor, i.e., a processing device, typically a central processing unit (CPU), and a memory, i.e., a storage device.

The memory includes a main storage unit such as a dynamic random access memory (DRAM) and an auxiliary storage unit such as a flash memory, for example. The auxiliary storage unit stores software including predetermined programs. The processor and the memory are operated according to the programs to perform the functions of the controller.

The method of manufacturing the SiC wafer 11 will be described below according to the sequence illustrated in FIG. 1. First, as illustrated in FIG. 3, the SiC ingot 13 is placed on the holding surface 4a such that the second surface 13b is held in contact with the holding surface 4a, and the second surface 13b is attracted under suction to the holding surface 4a (holding step S10).

After the holding step S10, a plurality of peel-off layers 19 (see FIG. 4A) each including a modified layer 15 and cracks 17 are formed in the SiC ingot 13 (peel-off layer forming step S20). FIG. 4A schematically illustrates in plan the SiC ingot 13 being processed in the peel-off layer forming step S20.

In FIG. 4A and the subsequent figures, lines with arrows on the first surface 13a of the SiC ingot 13 illustrated in plan represent the path followed by the focused spot P. In the SiC ingot 13 illustrated in plan, the modified layers 15 are dotted, and the cracks 17 are hatched. Further, paths that have already been followed by the focused spot P are indicated by solid lines, whereas paths that are to be followed by the focused spot P are indicated by broken lines.

In the peel-off layer forming step S20, the orientation of the flat surface 13d is identified using the microscope camera unit, and the chuck table 4 is turned by the rotary drive mechanism to adjust the orientation of the SiC ingot 13 in the XY plane. According to the present embodiment, the first directions A1 that are perpendicular to the flat surface 13d are brought substantially parallel to the X-axis.

Then, the position of the chuck table 4 in the XY plane is adjusted such that the focused spot P will traverse an end region of the SiC ingot 13 in the second directions A2, i.e., a lower portion of the SiC ingot 13 in FIG. 4A, along the first directions A1, and the height of the condensing lens 16 is adjusted such that the focused spot P will be positioned at the predetermined depth in the SiC ingot 13.

The depth of the focused spot P in the SiC ingot 13 is set to a position that is spaced 400 μm from the first surface 13a, i.e., the upper surface of the SiC ingot 13. However, the depth of the focused spot P in the SiC ingot 13 may appropriately be adjusted depending on the thickness of an SiC wafer 11 to be fabricated from the SiC ingot 13.

With the focused spot P thus adjusted in position, the siC ingot 13 and the focused spot P are moved relative to each other, i.e., processing-fed, along the X-axis. According to the present embodiment, the focused spot P is moved in the +X direction with respect to the SiC ingot 13 when they are processing-fed in an odd-numbered stroke.

After the focused spot P has been moved across the first surface 13a, the SiC ingot 13 and the condensing lens 16 are moved relative to each other, i.e., indexing-fed, a predetermined distance along the Y-axis. For example, the SiC ingot 13 and the condensing lens 16 are indexing-fed by a distance of 300 μm. According to the present embodiment, the focused spot P is moved in the +Y direction with respect to the SiC ingot 13.

Usually, when the SiC ingot 13 and the condensing lens 16 are indexing-fed, the laser beam L is continuously applied to the SiC ingot 13. However, the application of the laser beam L may temporarily be stopped while the SiC ingot 13 and the condensing lens 16 are being indexing-fed. After the SiC ingot 13 and the condensing lens 16 have been indexing-fed, the SiC ingot 13 and the focused spot P are processing-fed again while the laser beam L is being applied to the SiC ingot 13. According to the present embodiment, for accomplishing an increased throughput, the focused spot P is moved in the −X direction with respect to the SiC ingot 13 when they are processing-fed in an even-numbered stroke.

The processing-feeding and the indexing-feeding are alternately performed to form a plurality of peel-off layers 19 in the SiC ingot 13, each peel-off layer 19 including a modified layer 15 extending along the first directions A1 and cracks 17 developed from the modified layer 15.

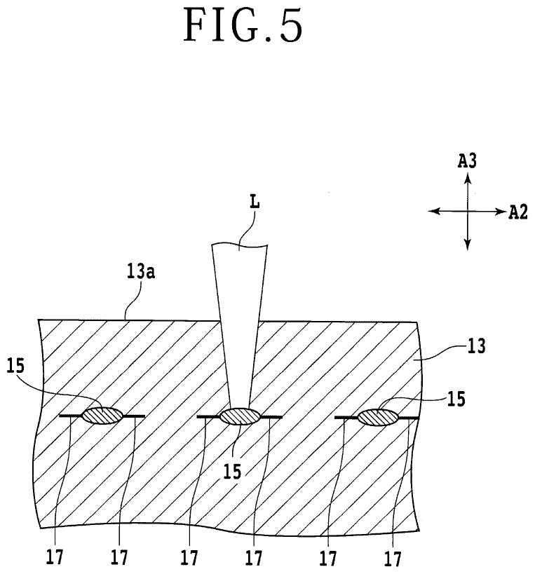

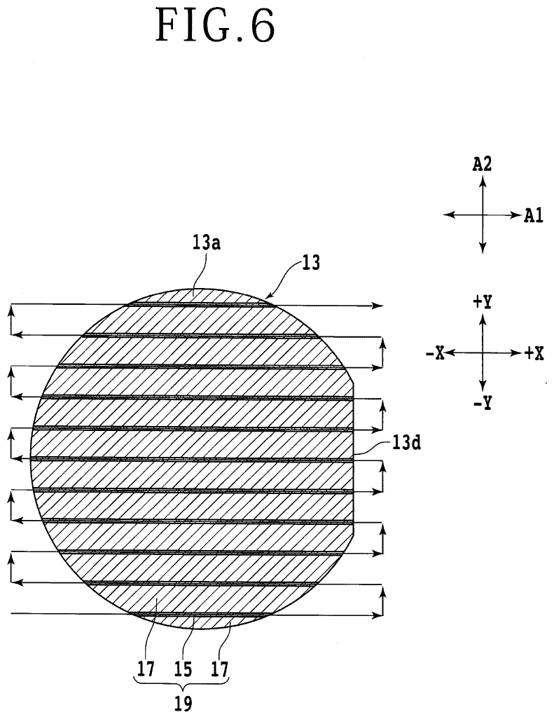

FIG. 4B schematically illustrates in plan the SiC ingot 13 with the plurality of peel-off layers 19 formed therein in the peel-off layer forming step S20. After the peel-off layer forming step S20, the SiC ingot 13 is processed in the crack developing step S30. FIG. 5 illustrates in enlarged fragmentary cross section the SiC ingot 13 being partly processed in the crack developing step S30, and FIG. 6 illustrates in plan the SiC ingot 13 entirely processed in the crack developing step S30.

In the crack developing step S30, the height of the condensing lens 16 is brought even with its height in the peel-off layer forming step S20. Specifically, the height of the focused spot P is adjusted to come even with its height in the peel-off layer forming step S20, after which the laser beam L is applied to a modified layer 15 formed in the SiC ingot 13.

In the present description, keeping the height of the focused spot P in the crack developing step S30 even with the height of the focused spot P in the peel-off layer forming step S20 means keeping the height of the focused spot P constant within an error of +1 μm along the thicknesswise direction 13c throughout both the crack developing step S30 and the peel-off layer forming step S20.

In the crack developing step S30, the laser beam L is applied to the modified layer 15 of at least one of the peel-off layers 19 formed in the peel-off layer forming step S20 along a longitudinal direction of the modified layer 15 from one end to the other end thereof. The laser beam L thus applied to the modified layer 15 causes the cracks 17 already developed from the modified layer 15 to be further developed and/or causes new cracks 17 to be developed from the modified layer 15.

Since the modified layer 15 contains the amorphous carbon that has a much higher absorption coefficient than the monocrystalline SiC, the laser beam L applied to the modified layer 15 is sufficiently absorbed by the modified layer 15. The energy of the absorbed laser beam L contributes to the development of the existing cracks 17 and/or the development of new cracks 17.

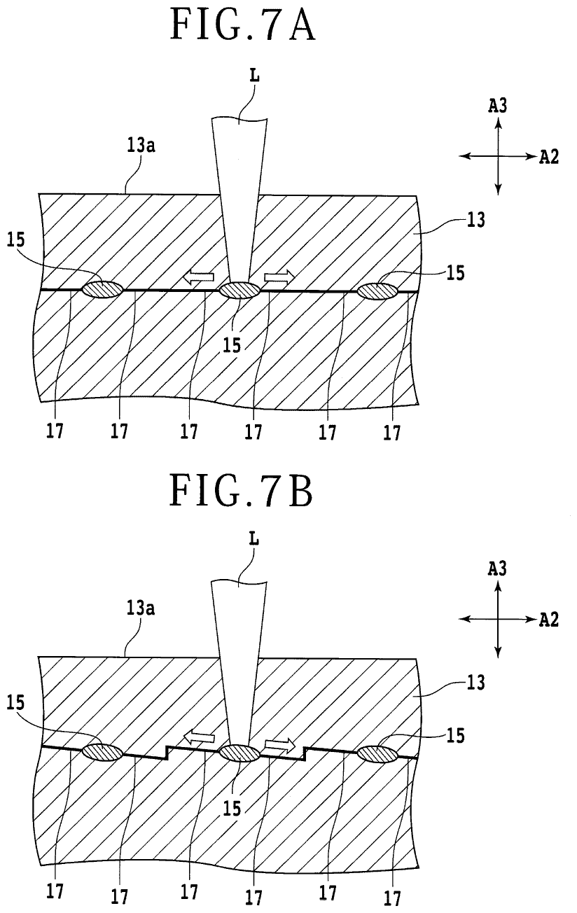

FIG. 7A illustrates in enlarged fragmentary cross section the SiC ingot 13 in which cracks 17 are being developed in the crack developing step S30. The cracks 17 are developed along a c-plane, i.e., the first surface 13a represented by (0001) according to the present embodiment, and joined to the cracks 17 from adjacent modified layers 15 along the second directions A2.

If the SiC ingot 13 has an off-angle, then a c-axis that is normal to the c-plane and a line normal to the first surface 13a do not extend parallel to each other, but form a predetermined angle therebetween. FIG. 7B illustrates in enlarged fragmentary cross section the SiC ingot 13 in which cracks 17 are being developed in an SiC ingot having an off-angle.

Inasmuch as the cracks 17 are developed along the c-plane, i.e., a cleavage plane of the SiC ingot 13, if the siC ingot 13 has an off-angle, then the cracks 17 are inclined depending on the off-angle as illustrated in FIG. 7B. Laser processing conditions in each of the peel-off layer forming step S20 and the crack developing step S30 are given by way of example below.
Wavelength of the laser beam: 1065 nm
Repetitive frequency of the laser beam: 120 kHz
Processing feed speed: 785 mm/s
Indexing-feeding distance: 150 μm
Average laser output power level: 9.5 W
Numerical aperture (N.A.) of the condensing lens: 0.8
Depth of the focused spot: 400 μm (depth from the first surface 13a)
Number of passes: 1

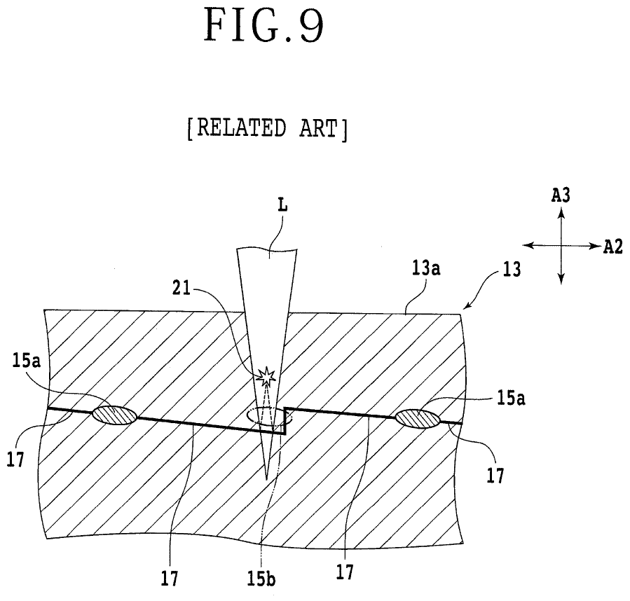

In a comparative example illustrated in FIG. 9 to be described later, the laser bean L tends to be reflected by cracks 17 formed between two first modified layers 15a when the laser beam L is applied to a region between the two first modified layers 15a. In the crack developing step S30 according to the present embodiment, however, the laser beam L applied to the SiC ingot 13 is not reflected by the cracks 17.

According to the present embodiment, since the laser beam L is not reflected by the cracks 17 and hence does not cause damage to the SiC wafer 11, the loss of material of the SiC ingot 13 is reduced compared with the comparative example in which the laser beam L is applied to a region between adjacent two of a plurality of first modified layers 15a to form a second modified layer 15b therebetween, as illustrated in FIG. 9.

In the crack developing step S30, a pulsed laser beam L having an output power level equal to or lower than the output power level of the laser beam L applied to the SiC ingot 13 in the peel-off layer forming step S20 may be applied to the SiC ingot 13.

For example, whereas the laser beam L has an average output power level of 9.5 W in the peel-off layer forming step S20, the laser beam L in the crack developing step S30 has an average output power level of 9.0 W. Even though the average output power level of the laser beam L in the crack developing step S30 is lower than the average output power level of the laser beam L in the peel-off layer forming step S20, the laser beam L is absorbed by the modified layer 15 containing the amorphous carbon, and the energy of the absorbed laser beam L is utilized to develop the cracks 17. Although the cracks 17 that are developed include components mainly in the second directions A2, they also include components in the first directions A1. Therefore, as the cracks 17 are developed, the cracks 17 are joined to each other.

In the crack developing step S30, the laser beam L whose average output power level is equal to or lower than the average output power level of the laser beam L in the peel-off layer forming step S20 is used. Consequently, the possibility that cracks 17 will be formed along the thicknesswise direction 13c is lower than if the laser beam L whose average output power level is higher than the average output power level of the laser beam L in the peel-off layer forming step S20 is used in the crack developing step S30.

As described above, the cracks 17 formed along the thicknesswise direction 13c need to be removed from the SiC wafer 11 by grinding, polishing, or the like. Accordingly, the reduced output power level of the laser beam L in the crack developing step S30 leads to a reduction in the volume of the ingot material to be discarded, i.e., the loss of material of the SiC ingot 13.

According to the present embodiment, the path followed by the focused spot P in the crack developing step S30 is the same as the path followed by the focused spot P in the peel-off layer forming step S20. However, the focused spot P may move in different sequences of strokes in the peel-off layer forming step S20 and the crack developing step S30. According to the present embodiment, in the crack developing step S30, the focused spot P moves along each of the modified layers 15 once, i.e., the number of passes is 1.

After the crack developing step S30, an SiC wafer 11 is peeled off from the SiC ingot 13 at the peel-off layers 19 that act as peel-off initiating points, with use of a peeling apparatus 20 as illustrated in FIGS. 8A and 8B (peeling step S40). FIG. 8A illustrates in side elevation the SiC ingot 13 being processed in the peeling step S40.

The peeling apparatus 20 has a chuck table 22 that is substantially equal in diameter to the chuck table 4 described above. The chuck table 22 is also substantially equal in structure to the chuck table 4 and has an upper surface functioning as a holding surface 22a for holding the SiC ingot 13 under suction.

A peeling unit 24 is disposed above the chuck table 22. The peeling unit 24 has a cylindrical movable rod 26 whose longitudinal axis extends vertically along the Z-axis. The movable rod 26 is coupled to a Z-axis moving mechanism, not depicted. The Z-axis moving mechanism is a ball-screw-type moving mechanism, for example, though it may be another actuator. The movable rod 26 is vertically movable along the Z-axis by the Z-axis moving mechanism.

The movable rod 26 has a lower end on which a disk-shaped suction head 28 is mounted. The suction head 28 has a frame and a porous plate, not depicted, as with the chuck table 22. The frame and the porous plate have respective lower surfaces that lie essentially flush with each other and in substantially parallel to the XY plane, and that jointly function as a holding surface 28a.

In the peeling step S40, the second surface 13b of the SiC ingot 13 with the peel-off layers 19 formed therein is held under suction on the holding surface 22a of the chuck table 22, and the first surface 13a of the SiC ingot 13 is held under suction on the holding surface 28a of the suction head 28.

Then, an external force is imposed on the SiC ingot 13. Specifically, a wedge, not depicted, is driven into a side surface of the siC ingot 13 in vertical alignment with the peel-off layers 19 in the SiC ingot 13, thereby applying an external force to the SiC ingot 13. It is preferable to drive a plurality of wedges, rather than a single wedge, into the side surface of the SiC ingot 13 at circumferentially spaced positions on the side surface of the SiC ingot 13.

When the external force is applied to the SiC ingot 13, the cracks 17 are further developed mainly along the second directions A2 at the depth in the SiC ingot 13 where the peel-off layers 19 have been formed. An external force may be applied to the SiC ingot 13 by other means than the wedges. For example, ultrasonic waves, i.e., elastic vibration waves in a frequency band in excess of 20 kHz, may be applied to the SiC ingot 13 to exert an external force on the SiC ingot 13.

If ultrasonic waves are applied to the SiC ingot 13, then the ultrasonic waves are applied to the SiC ingot 13 via a liquid such as pure water before the first surface 13a of the SiC ingot 13 is held under suction on the holding surface 28a of the suction head 28. Specifically, a liquid to which ultrasonic waves are applied is ejected from a nozzle to the SiC ingot 13. Alternatively, ultrasonic waves are applied from an ultrasonic horn via a liquid to the first surface 13a of the SiC ingot 13.

If a nozzle or an ultrasonic horn is used, then an external force is applied by ultrasonic waves to a local region, that is approximately 5 mm to 50 mm across, of the first surface 13a of the SiC ingot 13. Then, the nozzle or ultrasonic horn and the chuck table 22 are moved relative to each other to apply the external force to other regions of the first surface 13a.

By thus moving the nozzle or ultrasonic horn and the chuck table 22 relative to each other to apply the external force to successively different regions of the first surface 13a, the cracks 17 between the modified layers 15 are developed along the first surface 13a. The applied external force further develops the cracks 17 between the modified layers 15, making the peel-off layers 19 further weaker in mechanical strength than the other region of the SiC ingot 13 than the peel-off layers 19.

After the external force has been applied to the SiC ingot 13, the suction head 28 is lifted, i.e., moved upwardly along the +Z direction. The external force may be applied to the SiC ingot 13 concurrent with the ascent of the suction head 28 along the +Z direction. When the suction head 28 is lifted, the SiC wafer 11 is peeled off from the SiC ingot 13 at the peel-off layers 19 that act as peel-off initiating points.

FIG. 8B illustrates in side elevation the SiC ingot 13 and the SiC wafer 11 after the peeling step 40. When the SiC ingot 13 has been processed in the holding step S10 through the peeling step S40, the volume of the ingot material discarded from the SiC ingot 13 corresponds to a thickness ranging from 50 μm to 80 μm in the thicknesswise direction 13c of the SiC ingot 13.

After the peeling step S40, surface irregularities remaining on the surface of the SiC wafer 11 that has left the SiC ingot 13 at the peel-off layers 19 and surface irregularities remaining on the surface of the siC ingot 13 from which the SiC wafer 11 has been peeled off are removed by grinding, polishing, or the like. In this fashion, the SiC wafer 11 whose thickness is smaller than the thickness of the SiC ingot 13, i.e., the distance between the first surface 13a and the second surface 13b, is manufactured.

If another SiC wafer 11 is to be produced from the siC ingot 13 (YES in S50 illustrated in FIG. 1), then the sequence of the method goes back to the peel-off layer forming step S20. If no more SiC wafer 11 is to be produced from the SiC ingot 13 (NO in S50 illustrated in FIG. 1), then the sequence of the method comes to an end.

Rather than the SiC ingot 13, an SiC monocrystalline substrate, i.e., a workpiece, may be processed in the holding step S10 through the peeling step S40 to fabricate an SiC wafer 11 that is smaller in thickness than the SiC monocrystalline substrate.

The SiC monocrystalline substrate may be what is called a stand-alone substrate or a substrate having an epitaxial growth layer of SiC formed on the SiC wafer 11 that acts as a seed crystal.

### COMPARATIVE EXAMPLE

A comparative example according to JP2022-517543A referred to above will be described below with reference to FIG. 9. FIG. 9 illustrates in enlarged fragmentary cross section an SiC ingot 13 in which a laser beam L is reflected by cracks 17 between two first modified layers 15a.

According to the comparative example, the cracks 17 are formed to join the two first modified layers 15a to each other. When the laser beam L is applied to the SiC ingot 13 to form a second modified layer 15b between the two first modified layers 15a, if the laser beam L is reflected by the cracks 17 between the two first modified layers 15a, the region of the SiC ingot 13 that is to be fabricated as an SiC wafer 11 is damaged by the reflected laser beam L.

In FIG. 9, the second modified layer 15b is indicated by two-dot-and-dash lines. A damaged area 21 produced by the reflected laser beam L is formed above the second modified layer 15b. Since the damaged area 21 is eventually removed from the SiC wafer 11, the damaged area 21 increases the loss of material of the SiC ingot 13 compared with the embodiment described above of the present invention.

In FIG. 9, the SiC ingot 13 is illustrated as having an off-angle. Even if the SiC ingot 13 has no off-angle, it suffers a problem in that the laser beam L is reflected by the cracks 17 formed to join the two first modified layers 15a to each other.

By contract, in the crack developing step S30 according to the present embodiment, since the laser beam L is applied to the modified layer 15 formed in the peel-off layer forming step S20, the method according to the present embodiment is basically free of the problem that the laser beam L is reflected by the cracks 17.

### First Modification

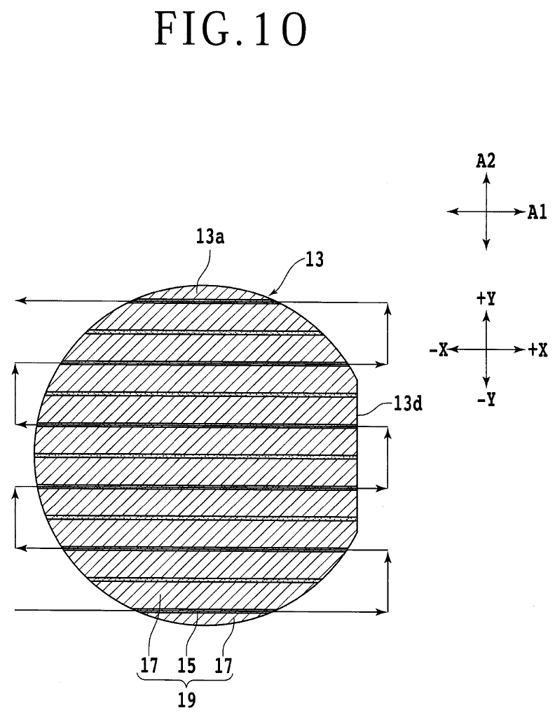

The crack developing step S30 according to a first modification will be described below with reference to FIG. 10. FIG. 10 illustrates in plan an SiC ingot 13 processed in the crack developing step S30 according to the first modification.

In the crack developing step S30 according to the first modification, the laser beam L is not applied to all the modified layers 15 formed in the SiC ingot 13, but applied to the modified layers 15 of an every predetermined number of ones of the peel-off layers 19 that are arrayed along the second directions A2. Specifically, the laser beam L is applied to every other one of the modified layers 15 arrayed along the second directions A2.

According to the first modification, since the laser beam L is applied to the modified layers 15 already formed in the Sic ingot 13 as with the above embodiment, the loss of material of the Sic ingot 13 is reduced compared with the comparative example (see FIG. 9) in which the laser beam L is applied between the first modified layers 15a to form the second modified layer 15b therebetween.

Further, the first modification is also advantageous in that, inasmuch as the number of modified layers 15 to which the laser beam L is applied in the crack developing step S30 is smaller than in the above embodiment, the period of time required to process the SiC ingot 13 with the laser beam L is shorter, and the loss of material of the SiC ingot 13 is reduced, as indicated by experimental results to be described below.

In FIG. 10, the laser beam L is applied to every other one of the modified layers 15. However, the laser beam L may be applied to every Nth one of the modified layers 15 (N is a natural number equal to or larger than 2) of the peel-off layers 19 depending on the indexing-feeding distance in the peel-off layer forming step S20 and the diameter of the SiC ingot 13, for example.

### Experimental Results

The results (indicated in Table 1 below) of experiments conducted to examine the loss of material of the SiC ingot 13 in a case where the SiC wafer 11 is fabricated from the SiC ingot 13 under a plurality of laser processing conditions will be described below. In Table 1, the phase “Pitch of modified layers 15” represents the distance in the indexing-feed direction between widthwise central lines of the modified layers 15.

The loss of material was calculated by converting the volume of the ingot material of the SiC ingot 13 that was eventually discarded by grinding the SiC wafer 11 and the SiC ingot 13 after the SiC wafer 11 was peeled off from the SiC ingot 13, into a length along the thicknesswise direction 13c.

The peel-off layers 19 that remain on the SiC wafer 11 and the SiC ingot 13 can be determined by an optical observation based on color and reflectance, for example. The SiC wafer 11 and the SiC ingot 13 were ground until the peel-off layers 19 were removed as confirmed by such an optical observation.

TABLE 1

| | Average output | Average output | | |
|---|---|---|---|---|
| | power level of | power level of | | |
| | laser beam L | laser beam L | | |
| | in peel-off | in crack | Pitch of | |
| | layer forming | developing | modified | Loss of |
| | step S20 | step S30 | layers 15 | material |
| Experiment | 9.5 W | 9.5 W | 150 μm | 75 μm |
| A | | | | |
| Experiment | 9.0 W | 9.0 W | 150 μm | 70 μm |
| B | | | | |
| Experiment | 9.0 W | N/A | 150 μm | 110 μm |
| C | | | | |
| Experiment | 11.5 W | N/A | 150 μm | 90 μm |
| D | | | | |

In the experiment A, the SiC ingot 13 was processed in the holding step S10 through the peeling step S40 to peel off the SiC wafer 11 from the SiC ingot 13 according to the above embodiment. In the peel-off layer forming step S20 and the crack developing step S30, the SiC ingot 13 was processed by the laser beam L under the laser processing conditions described above.

The experiment B corresponds to the first modification (see FIG. 10) described above. In the experiment B, the laser processing conditions described above were applied except that the average output power level of the laser beam L in the peel-off layer forming step S20 and the crack developing step S30 was 9.0 W. In the crack developing step S30, the laser beam L was applied to every other modified layer 15 as described above.

The experiment C corresponds to the comparative example (see FIG. 9) described above. In the experiment C, the laser processing conditions described above were applied except that the average output power level of the laser beam L in the peel-off layer forming step S20 was 9.0 W. In the experiment C, however, the peel-off layer forming step S20 was carried out in two cycles.

Specifically, after the peel-off layer forming step S20 was carried out in a first cycle to form a plurality of first modified layers 15a with the index-feeding distance of 300 μm, the peel-off layer forming step S20 was carried out in a second cycle to form a plurality of second modified layers 15b each in an intermediate region between adjacent two of the first modified layers 15a.

However, in the second cycle of the peel-off layer forming step S20, the positions in which to start forming the second modified layers 15b were adjusted so as to have the second modified layers 15b shifted 150 μm from the first modified layers 15a in the second directions A2. The indexing-feeding distance in the second cycle of the peel-off layer forming step S20 was 300 μm as with the first cycle of the peel-off layer forming step S20. In this manner, the modified layers 15 were formed at a pitch of 150 μm along the second directions A2. In the experiment C, the crack developing step S30 was not carried out.

The experiment D corresponds to a general method for forming a plurality of peel-off layers 19 in an SiC ingot 13 and thereafter peeling off an SiC wafer 11 from the SiC ingot 13 at the peel-off layers 19 that act as peel-off initiating points. In the experiment D, the laser processing conditions described above were applied except that the average output power level of the laser beam L in the peel-off layer forming step S20 had a relatively high level of 11.5 W. In the experiment D, the crack developing step S30 was not carried out either.

In the experiments A through D, the average output power level of the laser beam L in the peel-off layer forming step S20 is of a minimum level capable of peeling off the SiC wafer 11 from the SiC ingot 13. In the experiments A through D, after a plurality of peel-off layers 19 were formed in the SiC ingot 13 with an average laser output power level lower than the average output power level indicated in Table 1, an attempt was made to peel off an SiC wafer 11 from the SiC ingot 13. However, no SiC wafer 11 was peeled off from the SiC ingot 13.

Providing the other laser processing conditions than the average output power level of the laser beam L in Table 1 remained unchanged, the average output power level of the laser beam L in the peel-off layer forming step S20 in Table 1 was of a minimum value, i.e., a lower limit value, capable of peeling off an SiC wafer 11 from the SiC ingot 13.

In the experiments A and B, in a case where a lower average output power level than the average output power level in Table 1 was used, the average output power level of the laser beam L was the same in both the peel-off layer forming step S20 and the crack developing step S30.

In the experiments A and B, the loss of material of the siC ingot 13 was reduced compared with the experiments C and D. Particularly, the decimation of regions irradiated with the laser beam L in the crack developing step S30, as was the case with the experiment B, was effective to reduce the loss of material.

### Second Modification

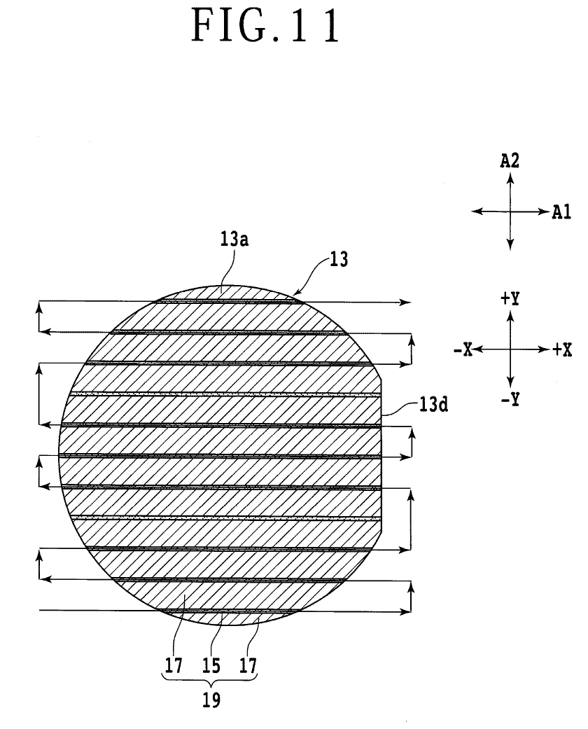

The crack developing step S30 according to a second modification will be described below with reference to FIG. 11. FIG. 11 illustrates in plan an SiC ingot 13 processed in the crack developing step S30 according to the second modification.

In the crack developing step S30 according to the second modification, the laser beam L is not applied to every other one of the modified layers 15. Rather, after the laser beam L is applied to first three modified layers 15 along the second directions A2, the laser beam L is not applied to, but skipped, the next modified layer 15.

Then, similarly, after the laser beam L is applied to following three modified layers 15 along the second directions A2, the laser beam L is not applied to, but skipped, the next modified layer 15. In this fashion, a plurality of modified layers 15 irradiated with the laser beam L in the crack developing step S30 and one or more modified layers 15 not irradiated with the laser beam L in the crack developing step S30 are alternately arrayed in the second directions A2.

In other words, the crack developing step S30 according to the second modification includes an irradiating step of irradiating, with the laser beam L, the modified layers 15 of a first number of peel-off layers 19 that are successively arrayed in the second directions A2 with no unirradiated modified layers 15 being present amidst those modified layers 15, and an unirradiating step of leaving, unirradiated with the laser beam L, the modified layers 15 of a second number of peel-off layers 19 that are disposed adjacent in the second directions A2 to the first number of peel-off layers 19 that are successively arrayed in the second directions A2, the irradiating step and the unirradiating step being alternately repeated along the second directions A2.

In the crack developing step S30 according to the second modification illustrated in FIG. 11, the first number represents 3, and the second number represents 1. However, the first number in the irradiating step and the second number in the unirradiating step may be varied as appropriate depending on the indexing-feeding distance in the peel-off layer forming step S20 and the diameter of the SiC ingot 13, for example. The first number may represent a natural number of 2 or larger, whereas the second number may represent a natural number.

According to the second modification, as with the embodiment described above, the loss of material of the SiC ingot 13 is reduced compared with the comparative example illustrated in FIG. 9 in which the laser beam L is applied between the first modified layers 15a to form the second modified layer 15b therebetween.

The structural and methodological details of the embodiment and the modifications may be changed and modified as appropriate without departing from the scope of the present invention. In the above embodiment and first and second modifications, the height of the focused spot P remains constant within an error of +1 μm along the thicknesswise direction 13c throughout both the peel-off layer forming step S20 and the crack developing step S30.

Nevertheless, the height of the focused spot P in the crack developing step S30 may not necessarily be the same as the height of the focused spot P in the peel-off layer forming step S20. Even if the height of the focused spot P is different in the peel-off layer forming step S20 and the crack developing step S30, the laser beam L that is applied to the modified layers 15 in the crack developing step S30 can sufficiently be absorbed by the amorphous carbon. However, it is easier to keep the focused spot P at the same height in the peel-off layer forming step S20 and the crack developing step S30 from the standpoint of the process of manufacturing SiC wafers 11 from an SiC ingot 13.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A method of manufacturing a wafer from a workpiece shaped as an ingot or a monocrystalline substrate, the wafer having a thickness smaller than a thickness of the workpiece, comprising:
a peel-off layer forming step of forming in the workpiece a plurality of peel-off layers each including a modified layer extending along a first direction that is perpendicular to thicknesswise directions of the workpiece and cracks developed from the modified layer by, while a condensing lens for converging a pulsed laser beam having a wavelength transmittable through the workpiece is adjusted to a predetermined height so as to position a focused spot of the laser beam at a predetermined depth in the workpiece, alternately repeating processing-feeding for moving the workpiece and the focused spot of the laser beam relative to each other along the first direction and indexing-feeding for moving the workpiece and the condensing lens relative to each other along a second direction that is perpendicular to the thicknesswise directions of the workpiece and the first direction;
a crack developing step of further developing the cracks that have been developed from the modified layer of at least one of the peel-off layers formed in the peel-off layer forming step and/or developing new cracks from the modified layer of the at least one of the peel-off layers by applying the laser beam to the modified layer of the at least one of the peel-off layers along longitudinal directions of the modified layer; and
a peeling step of peeling off the wafer from the workpiece at the peel-off layers that act as peel-off initiating points.

2. The method of manufacturing a wafer according to claim 1, wherein
the crack developing step includes applying the laser beam to the modified layers of an every predetermined number of ones of the peel-off layers that are arrayed along the second direction.

3. The method of manufacturing a wafer according to claim 1, wherein
the crack developing step includes an irradiating step of irradiating, with the laser beam, the modified layers of a first number of peel-off layers that are successively arrayed in the second direction with no unirradiated modified layers being present amidst the modified layers, and an unirradiating step of leaving, unirradiated with the laser beam, the modified layers of a second number of peel-off layers that are disposed adjacent in the second direction to the first number of peel-off layers that are successively arrayed in the second direction, the irradiating step and the unirradiating step being alternately repeated along the second direction.

4. The method of manufacturing a wafer according to claim 1, wherein
the crack developing step includes applying to the workpiece a laser beam having an output power level equal to or lower than an output power level of the laser beam applied to the workpiece in the peel-off layer forming step.

5. The method of manufacturing a wafer according to claim 1, wherein
the crack developing step includes applying the laser beam to the workpiece after having adjusted the height of the focused spot of the laser beam to a height same as the height of the focused spot in the peel-off layer forming step.
